(19) United States
(12) Patent Application Publication
(10) Pub. No.: US 2009/0061398 A1
(43) Pub. Date: Mar. 5, 2009

(54) Language Teaching Method and Apparatus

(76) Inventors: Gregory Keim, Broadway, VA (US); John Fairfield, Bridgewater, VA (US)

Correspondence Address: GIBSON & DERNIER L.L.P., 900 ROUTE 9 NORTH, SUITE 504, WOODBRIDGE, NJ, 07095, US

(21) Appl. No.: 11/846,188

(22) Filed: Aug. 28, 2007

(51) Int. Cl. G09B 19/06; G09B 19/00

(52) U.S. Cl. 434/157

(57) ABSTRACT

A student is taught a language through the introduction of target expressions including features, such as specific words or phrases and language structure. The student is presented one or more reference expressions made up of target expression with one or more of its features altered, while maintaining semantic meaningfulness, and he is prompted with a prompting expression designed to elicit the target expression as a response, in view of the at least one reference expression.

### BACKGROUND OF THE INVENTION

The present invention relates generally to teaching machines and, more particularly concerns a method and system most advantageously used for teaching a language. The methodology also is applicable to fields outside of language teaching.

Traditional methods for teaching a language, in particular a foreign language, are far from enjoyable for the student. He must spend a great deal of time learning rules of grammar and syntax and must memorize words as translations of the same words in his own language. The only exposure to correct pronunciation might be on a recording or during “discussions” in the classroom. At those times, the student finds himself mentally composing his recitation in his native language and then translating it. The usual result is a halting, stilted recital, replete with grammatical and syntactic errors introduced by the impromptu translation process. A student who learns a language this way may be totally lost during a conversation among native speakers of the language.

On the other hand, when we first learn a language as young children, the experience is entirely different. We are fully immersed in a natural learning process in which we learn words, grammar and syntax interactively, through deductive reasoning, in context, and by emulating others. In time, we develop a flowing communication style, without the need to translate or to be concerned about rules. It would be desirable to be able to emulate this kind of learning process in learning a second language.

Such systems of teaching a user language using immersion are known to some extent in the prior art. However, to best measure the user's progress and help in learning to speak, the system must cause the user to speak naturally. Simply showing the user target language text to be read aloud is less than optimum, because read speech is not spoken the same way as natural speech not being read. Thus, any computer system being used in the teaching process will not really be measuring natural language speaking.

Accordingly, there exists a need in the art for a language teaching system that can be used to cause natural speech to occur in a target language to assist in the user practicing, the system measuring progress, and the user learning to speak natively.

### SUMMARY OF THE INVENTION

In accordance with one aspect of the invention, a student is taught a language through the introduction of target expressions including features, such as specific words or phrases and language structure. The student is presented one or more reference expressions made up of the target expression with one or more of its features altered, while maintaining semantic meaningfulness, and he is prompted with a prompting expression designed to elicit the target expression as a response, in view of the presented reference expressions.

For example, the student might be presented a series of reference expressions in writing, in a graphic presentation, and/or in audible form. Each reference expression preferably varies from the target expression in one feature, although more than one feature is also possible. That feature may be a word or phrase, or it may be a variation in structure. The target expression is then presented in graphic form (a prompting expression), or some other non-literal form, and the student is prompted to write and/or speak the target expression.

It is a feature of the invention that a target expression is learned without it ever being presented to the student in the form sought to be taught. Instead, the student learns it interactively, entirely in the language being studied, by analogy and through deductive reasoning. In other words, the student is not just memorizing words, phrases and rules but is actually discovering the language.

It will be appreciated that this form of teaching also incorporates an element of entertainment, which makes the learning process more interesting and retains the student's attention.

### BRIEF DESCRIPTION OF THE DRAWINGS

The foregoing brief description, as well as further objects, features, and advantages of the present invention will be understood more completely from the following detailed description of presently preferred, but nonetheless illustrative, embodiments with reference being had to the accompanying drawings, in which:

FIG. 1 is a schematic block diagram of a system embodying the present invention;

FIGS. 2(A) through 2(D) are representations of exemplary presentations generated by a computerized system embodying the invention; and

FIGS. 3(A) through 3(D) are representations of additional exemplary presentations generated by a computerized system embodying the invention.

### DETAILED DESCRIPTION OF THE PREFERRED EMBODIMENTS

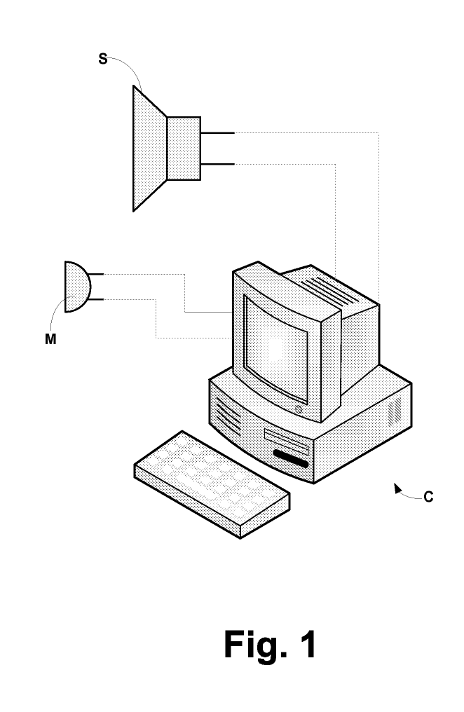

It is contemplated that a system embodying the present invention could be realized by making use of a personal computer. FIG. 1 is a schematic block diagram illustrating such a system. A computer system C, including a keyboard and pointing device (not shown) and a display would be programmed with the teaching method and would contain storage for related data. A microphone M is provided to capture spoken responses from the student, and a speaker provides audible communications from the computer.

In operation of the system, the student receives graphic and text communications via the display and audible communications, such as spoken language, via the speaker. He may provide textual responses via the keyboard and spoken responses via the microphone. For purposes of illustration, it will be assumed that the student is being taught a foreign language.

In accordance with the method of the present invention, a student learns a language by being taught a series of “target expressions.” An expression may be a sentence, but it can be a simple clause. An expression is made up of “features”, including not only words and phrases, but also language structure. As used herein, “language structure” will be understood to mean not only specific structure, such as sentence structure, but also semantics, form, gender number, case, level of formality or any other similar variables.

The target expression is taught to the student without ever being presented directly in text for reading by the student. Optionally, the system may also exclude presenting the expression orally. Instead, the student is presented with at least one reference expression and, preferably, a plurality of reference expressions. A reference expression resembles the target expression but has at least one feature altered, while maintaining semantic meaningfulness. The altered feature may be a word or phrase, or it might be an alteration in structure. After the reference expressions are present, the student is prompted with a prompting expression, which is designed to elicit the target expression as a response, in view of the reference expression.

From the point of view of the system, a set of target expressions would be stored in the memory of the computer C and/or in disk storage, or the like. The teaching computer program accesses these in turn. As is well known the sequence may be adaptive in relationship to the student's progress. The sequence may also depend upon which other words and phrases in the system that the system concludes have been properly mastered by the student.

After a target sequence is selected, the program generates one or more reference expressions, from the target expression, by modifying features in the target expression. The program is designed to assure that the reference sequences are semantically meaningful in the language being taught. Preferably a sequence of reference expressions is presented to the student in graphic and written form on the display of computer C and in spoken form via speaker S. These are followed by a prompting expression, preferably the target expression in graphic form only, with an instruction to write and speak the expression. The student's response is received via the keyboard and microphone M, and program in computer C compares it to the correct response.

Preferably, an incorrect response will result in the computer program generating new reference expressions for the target expression, followed by the same prompting expression. A correct response will cause the program to move on to the next target expression. However, the fact that the target expression was incorrectly articulated by the user may be used by the system in any of a variety of manners to adjust future lessons in the target language. For example, the system could emphasize the incorrectly articulated words and concepts. Thus, if the user saw a horse, but stated the target language for a chicken, the system could go to a lesson that teaches the manner in which to say chicken or horse or both.

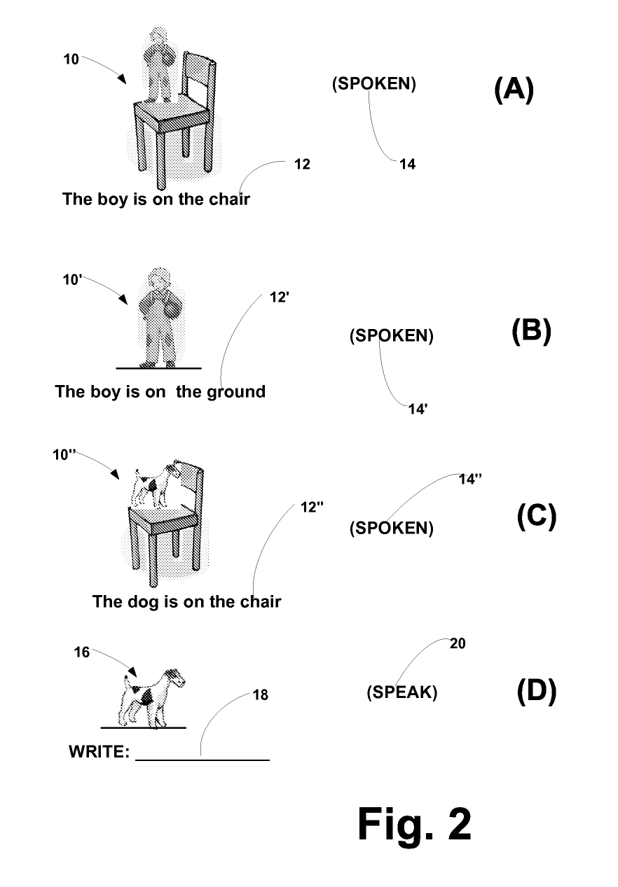

This process will be demonstrated with an example. Suppose the student is to be taught the target expression “the dog is on the ground”. FIG. 2, comprising FIGS. 2(A) through 2 (D) constitutes a representative computer display (or series of displays). In FIG. 2(A), the student is presented with a graphic 10 showing a boy standing on a chair, below which is presented the written expression 12 (“The boy is on the chair”) in the language being taught, and the spoken expression 14 may be played the speaker S, also in the language being taught. Similarly, in FIG. 2(B), the student is presented with a graphic 10′, a written expression 12′, and the spoken expression 14′ for “the boy is on the ground.” This is followed FIG. 2(C) by a similar presentation of “the dog is on the chair” (graphic 14″, written expression 12″, and audio message 14″). Finally, in FIG. 2(D), the student is presented with a graphic 16 showing a dog standing on the ground (this represents the target expression), the prompting expression, and is requested to write (18) and/or to speak (18) the prompting expression. As a result of examples offered by the reference expressions, the student will, by analogy, deduce the correct responses.

In shortcut form, the target expression can be represented as “The Y is on the B”, where Y is “dog” and B is “ground”, and this sequence of expressions can be represented as follows:

| | | |
|---|---|---|
| The X is on the A | | |
| The X is on the B | {close oversize brace} | (Reference Expressions) |
| The Y is on the A | | |
| The Y is on the B | | (Prompting Expression) |

The last expression is a prompt only, not the actual expression.

The student's responses are compared with the correct ones, and upon the occurrence of a match, the student is praised and moves on to the next target expression. Should the student provide the wrong response, he will be presented with a new series of reference expressions, in an effort to elicit the correct response. Should the student provide the correct response by with an inaccurate pronunciation, the correct pronunciation is played through speaker S, and the student may be requested to repeat it.

Thus, the response from the computer system may be different depending upon whether the student gave the incorrect response or whether he gave the correct response but with an incorrect pronunciation.

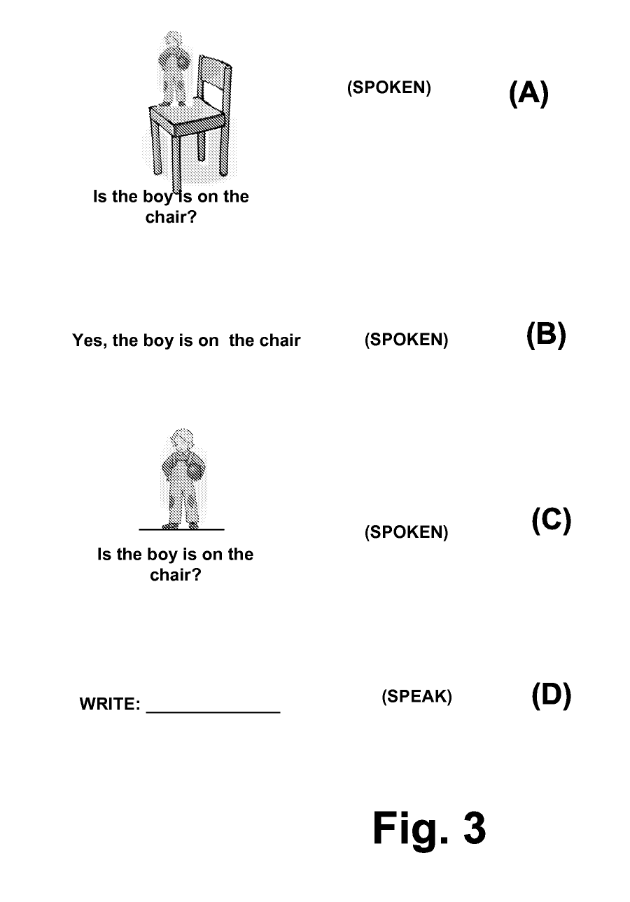

In the preceding example, the reference expressions differ from the target expression in that one word was different. FIGS. 3(A) through 3(D) represent a computer presentation similar to that of FIGS. 2(A) through 2(D). In this case, the target expression is “No, the boy is not on the chair”, and the reference expressions differ from it only in structure. The shortcut form for the sequence of expressions is:

| | | |
|---|---|---|
| Is the X on the A? | | |
| Yes, the X is on the A. | {close oversize brace} | (Reference Expressions) |
| Is the X on the A? | | |
| No, the X is not on the A. | | (Prompt Only) |

It should be appreciated that the relatively simple expressions have been utilized for the purpose of illustration. In practice, most sophisticated and complex expressions could be utilized, especially for more advanced students. An example of a more complex series of expressions might be:

| | | |
|---|---|---|
| Is the boy swimming? | | |
| No. the boy is not swimming. | {close oversize brace} | (Reference Expressions) |
| Is the dog swimming? | | |
| Yes, the dog is swimming. | | (Prompt Only) |

Where the target expression is “Yes, the dog is swimming”

It is noted that the manner in which the reference expression is presented, and the manner in which the target expression is conveyed by the student, need not be limited to the images, text, and audio as exemplified above. Instead, other combinations are possible. For example, a user can have the reference expression displayed in test and spoken in audio, and be prompted to pick an image that corresponds to the target expression. Or, a user can be prompted with the reference expression in text and images, and be asked to convey the target expression in text, or orally, or both.

The target and reference expressions can themselves include combinations of the foregoing. For example, if the reference expression includes two phrases, one can be conveyed with an image and text, and another phrase can be conveyed with an image an audio. Various combinations of audio, text and images may be used for the target or reference expressions, or for the phrases comprising them.

Although preferred embodiments of the invention have been disclosed for illustrative purposes, those skilled in the art will appreciate that many additions, modifications and substitutions are possible without departing from the scope and spirit of the invention as defined by the accompanying claims.

What is claimed:

1. A method for teaching a student a target expression in a language being learned, the target expression having features, including specific words or phrases and language structure, including one of semantics, form, gender and number, tone, prosoday, level of formality and case, said method comprising the steps of:
presenting to the student at least one reference expression comprising the target expression with one of its features altered, while maintaining semantic meaningfulness;
prompting the student with a prompting expression designed to elicit the target expression as a response, in view of the at least one reference expression.

2. The method of claim 1, further comprising comparing the student's response with the target expression and, if the comparison fails, repeating the presenting and prompting steps, with different reference expressions, the sequence of presenting, prompting and comparing being repeated until the comparison succeeds.

3. The method of claim 1 wherein a reference expression is presented in at least one of visual form, written form and a correctly spoken expression.

4. The method of claim 3 wherein the prompting expression is presented in visual form only.

5. The method of claim 1 wherein the prompting expression is presented in one of visual form and a correctly spoken expression.

6. The method of claim 1 wherein said presenting step comprises presenting at least two different reference expressions in sequence.

7. The method of claim 6, wherein an altered feature in a reference expression is a word or phrase, while the structure of the target expression is retained in an altered reference expression.

8. The method of claim 7, wherein the prompting expression differs in a word or phrase from the target expression and a reference expression, while the structure of the target expression is retained in the prompting expression.

9. The method of claim 8, wherein two reference expressions are provided and one reference expression and the prompting expression differ from the target expression in a word or phrase and the other reference expression differs from the target expression in two words or phrases, the other reference expression being presented first.

10. The method of claim 6, wherein an altered feature in a reference expression is a change in structure of the target expression.

11. A language instruction method for eliciting a designed user response, comprising the machine-executed steps of:
accessing data representing one or more target text items;
accessing data representing one or more reference text items, based on the data related to the one or more target text items;
accessing data representing an expression structure;
applying the expression structure to the one or more target text items to generate a target expression, wherein the target expression is semantically meaningful;
applying the expression structure to the one or more reference text items to generate at least one reference expression, wherein a reference expression is semantically meaningful;
presenting the reference expression and at least one visual presentation associated with the reference expression in a display frame;
in the same display frame, presenting at least one visual presentation associated with the target expression; and
eliciting a user response with respect to the target expression.

12. The method of claim 11 wherein the elicited user response is designated visually.

13. The method of claim 11 wherein there are at least two reference text items and wherein the reference expression comprises at least two statements that have a prescribed relationship to each other, and wherein the target expression also includes at least two statements having the prescribed relationship to each other, and wherein said eliciting includes displaying one of said statements of said target text and only partially a second of said statements of said target text, such that said user will complete said second statement in a target language.

14. The method of claim 13 wherein said displaying includes displaying the reference expression and partially the target expression along with a series of images corresponding to said expressions to assist in causing a user to complete said target expression.

15. The method of claim 14 wherein the prescribed relationship is question and answer.

16. The method of claim 13 wherein the said reference expression includes two different relationships between objects, and said target expression includes the same two different relationships between different objects.

17. A method for teaching a target language, comprising displaying at least four items, a first and second of said items having a prescribed relationship to each other, said first and second items being displayed with associated text, images, and/or audio, the items having a prescribed relationship to each other, a third and fourth of said items also having said prescribed relationship to each other, and being displayed along with associated text, audio, and or images, the text or audio associated with the fourth item being incomplete so that a user completes said text or audio in a target language.

18. A method of causing a user to produce sound in a target language comprising displaying visually a sequence of phrases, the sequence forming a pattern, the pattern being predictable by the user, the phrases being at least partially in the target language, at least a portion of at least one of the phrases being omitted to cause the user to articulate an omitted portion in the target language.

19. The method of claim 18 wherein said displaying visually includes at least in part displaying text and associated images.

20. The method of claim 18 wherein said displaying includes displaying text which comprises a series of questions and answers.

21. The method of claim 20 wherein each answer is displayed both textually and with an image.

22. The method of claim 18 wherein said display is accompanied by audio that speaks at least some of the displayed phrases in a manner that associates particular phrases with particular audio.

23. The method of claim 19 wherein said sequence comprises several pairs of phrases, each phrase of each pair of phrases being related to another member of said pair as opposites.

24. A method comprising, displaying on a computer screen, a sequence of images, forming a description of each image by using a predetermined, prestored, expression structure, and by inserting different instances of reference text and target text separately into said expression structure, thereby forming a separate reference expression or target expression associated with each image, and omitting at least a portion of the target expression associated with at least one of said images so that a user is caused to verbalize said target expression in response to a display of said images, said reference expressions, and said target expressions, and wherein a subsequent sequence of images, reference expressions, and target expressions is determined based upon said verbalization of said target expression being done correctly or not.

25. The method of claim 24 wherein the reference expression includes one or more questions and answers.

26. The method of claim 24 wherein the reference expression includes a series of statements paired together, and wherein members of each pair have a predetermined, same, relationship to each other, such that said relationship conveys the desired target expression to be verbalized to said user.

27. The method of claim 24 further comprising utilizing a threshold to determine whether the verbalization is correct enough to move to a more difficult sequence.

28. The method of claim 24 further comprising repeating the sequence without the images but with the text if the verbalization yields a predetermined level of proficiency.

29. The method of claim 24 wherein images and text are displayed for each of four different items, and wherein audio is played for three of the four.

30. The method of claim 24 wherein proficiency results are stored and used in an algorithm to select a subsequent sequence of images for utilizing in execution of said method of claim 14.

31. The method of claim 1 wherein the reference expression is presented using at least one of a group including audio, image, or text, and the target expression is conveyed using at least one of a group including audio, image, or text, and wherein the target expression is conveyed using a least one member of said group different from the member(s) of said group used to present said reference expression.
